(19) United States
(12) Patent Application Publication
(10) Pub. No.: US 2022/0236022 A1
(43) Pub. Date: Jul. 28, 2022

(54) HEAT EXCHANGER COMPRISING AT LEAST ONE PARTICLE FILTER, METHOD OF ASSEMBLING SUCH A HEAT EXCHANGER

(71) Applicant: L'Air Liquide, Société Anonyme pour l'Etude et l'Exploitation des Procédés Georges Claude, Paris (FR)

(72) Inventors: Eric MASLIAH, Brunoy (FR); Gilles LEBAIN, Thiais (FR); Lucovic AMANT, Vaires sur Marne (FR)

(21) Appl. No.: 17/584,549

(22) Filed: Jan. 26, 2022

(30) Foreign Application Priority Data
Jan. 26, 2021 (FR) 2100727

(51) Int. Cl. F28F 19/01; F28F 9/02; B01D 39/12; B01D 39/20; B01J 19/00

(52) U.S. Cl. CPC F28F 19/01; F28F 9/02; B01D 39/12; F28F 21/083; B01D 39/2044; B01D 39/2034; B01J 19/0013; B01D 39/2041

(57) ABSTRACT

The invention concerns a heat exchanger having an exchange body having first passages for the flow of a first fluid and second passages for the flow of a second fluid exchanging heat with the first fluid, a first inlet manifold for introducing the first fluid into the first passages, a first outlet manifold for discharging the first fluid from the first passages). The heat exchanger also includes an inlet filter arranged facing the inlet surface of the exchange body, and/or an outlet filter arranged facing the outlet surface of the exchange body, the inlet filter and/or the outlet filter having a sheet metallic material selected from a metal gauze, a non-woven fabric of metallic fibres, a sintered metallic powder or sintered metallic fibres.

### CROSS REFERENCE TO RELATED APPLICATIONS

This application claims the benefit of priority under 35 U.S.C. § 119 (a) and (b) to French Patent Application No. 2100727, filed Jan. 26, 2021, the entire contents of which are incorporated herein by reference.

### BACKGROUND

The present invention concerns a heat exchanger, in particular a heat exchanger of the type with plates and brazed fins, comprising at least one filter limiting the introduction of undesirable particles into the body of the heat exchanger or retaining particles fulfilling a specific function inside said body of the heat exchanger.

The present invention applies in particular in the field of hydrogen liquefaction. In particular, the invention may be applied to a catalytic heat exchanger which liquefies a flow of gaseous hydrogen against a flow of liquid nitrogen, and a liquefaction method using said heat exchanger.

The present invention also applies to the separation of gas by cryogenics, in particular the separation of air by cryogenic distillation. In particular, the present invention may apply to a heat exchanger which vaporises a flow of liquid, for example liquid oxygen, nitrogen and/or argon, by exchange of heat with a flow of gas, for example air or nitrogen.

The present invention may also apply to a heat exchanger which vaporises at least one flow of liquid-gas mixture, for example a mixture of hydrocarbons, through exchange of heat with at least one other fluid to be liquefied, for example natural gas.

One technology that is commonly used for heat exchangers is that of brazed plate heat exchangers, which make it possible to obtain highly compact components that afford a large heat-exchange surface area and low pressure losses. These exchangers comprise one or more exchange bodies formed by a set of parallel plates between which spacer elements, such as corrugated structures or corrugations, which form finned heat exchange structures, may be inserted. The stacked plates form between them a stack of flat passages for different fluids to be brought into a heat exchange relationship. The exchangers comprise fluid manifolds equipped with inlet and outlet pipes for introducing fluids into the exchange body and for discharging fluids from the exchange body.

Certain heat exchangers may require the use of a fluid filtration device in order to limit or prevent the introduction of solid particles into the exchange body which could reduce the thermal and hydraulic performance of the heat exchanger.

In other heat exchangers, it is however necessary to retain particles inside the body of the heat exchanger. These particles may be arranged inside passages of the exchange body so as to perform different functions therein. In catalytic heat exchangers in particular, the particles are formed from a catalyst material which produces a chemical reaction with the fluid circulating in the passages.

In particular, catalytic heat exchangers are known which are designed for the liquefaction of hydrogen, in which the ortho-hydrogen molecules are converted into para-hydrogen molecules during liquefaction by means of a suitable catalyst. In these heat exchangers, the inlet and outlet manifolds for introduction and discharge of hydrogen are generally dome-shaped, covering the fluid inlet and outlet surfaces of the body of the heat exchanger. In order to limit the movement of catalyst particles in the passages of the heat exchanger, the internal volume of the inlet and outlet manifolds is also filled with catalyst.

The body and the manifolds of the heat exchanger are filled after these elements have been brazed together. A heat exchanger equipped with such a filling device is partially depicted schematically in FIG. 8. The catalyst is distributed through one or more vertical tubes 100 situated at the top of the heat exchanger and connected to the internal volume of a manifold. Filling takes place by gravity flow of the catalyst particles through the vertical tubes 100 by means of specific distribution nozzles. The manifold is also equipped with a lateral tube 200 in which cylindrical filtration cartridges are inserted before filling with the catalyst. These cartridges are made of a porous material designed to allow fluid to pass into the manifolds but to block the catalyst particles. A fluid inlet duct 300 is connected to the lateral tube such that the fluid is distributed in the heat exchanger on passing through the filtration cartridge.

This solution leads to a complex architecture requiring the attachment of numerous pipes to the heat exchanger manifolds. In addition to the complexity of production and use of filtration cartridges, this solution pointlessly increases the volume of catalyst used since the manifolds are also filled therewith. The introduction of catalyst into the exchange body is also complex and requires specific tooling. The homogeneity of distribution of the catalyst particles between the different passages of the exchange body is difficult to control.

### SUMMARY

The object of the present invention is in particular to solve all or some of the above-mentioned problems by proposing a heat exchanger equipped with a filtration device, the design and use of which are simpler than in the prior art, and which also allows, in particular when the heat exchanger is intended to implement catalytic reactions, retention of the catalyst in the passages and an easier and better controlled filling of the passages during production of the heat exchanger.

A solution according to the invention is therefore a heat exchanger comprising an exchange body having a plurality of first passages for the flow of a first fluid and a plurality of second passages for the flow of a second fluid to be brought into a heat exchange relationship with the first fluid, a first inlet manifold for introducing the first fluid into the first passages, a first outlet manifold for discharging the first fluid from the first passages, the exchange body having an inlet surface at which the first passages are fluidically connected to the first inlet manifold, and an outlet surface at which the first passages are fluidically connected to the first outlet manifold, characterized in that the heat exchanger also comprises an inlet filter arranged facing the inlet surface of the exchange body, and/or an outlet filter arranged facing the outlet surface of the exchange body, the inlet filter and/or the outlet filter comprising a sheet metallic material selected from a metal gauze, a non-woven fabric of metallic fibres, a sintered metallic powder or sintered metallic fibres.

Depending on the case, the exchanger according to the invention may comprise one or more of the features listed below.

The sheet metallic material has an open surface density ranging from 15 to 35% or a pore volume density ranging from 75 to 98%.

The sheet metallic material is formed fully or partly of steel, in particular stainless steel, nickel or nickel alloy, in particular alloy comprising between 50% and 75% nickel by weight.

The sheet metallic material has a thickness of 0.20 to 0.75 mm.

The sheet metallic material is a woven fabric of metallic wires, said wires having a diameter of 0.10 to 0.30 mm, preferably 0.10 to 0.25 mm.

The sheet metallic material comprises at least a series of first metallic wires interlaced with a second series of metallic wires so as to form meshes, each mesh being delimited between two consecutive first wires and two consecutive second wires, the meshes having an opening of 0.07 mm to 0.15 mm.

The inlet filter and/or the outlet filter comprises a peripheral frame which extends along at least part of the contour of the sheet metallic material, in particular the inlet filter and/or the outlet filter is attached between an upper part and a lower part of said peripheral frame.

The heat exchanger comprises an inlet filter attached to said first inlet manifold, and/or an outlet filter attached to said first outlet manifold, wherein in a section plane parallel to the inlet surface or outlet surface of the exchange body, the inlet filter and/or outlet filter has an outer form which is substantially complementary to the inner form of the first inlet manifold or first outlet manifold in said sectional plane.

The heat exchanger comprises an inlet filter attached to the exchange body at the inlet surface, and/or an outlet filter attached to the exchange body at the outlet surface, in particular the inlet filter is attached to the exchange body at the inlet surface via an intermediate piece.

The intermediate piece is an angle piece with a plurality of sides with L-shaped cross-section, each side comprising a first wing extending parallel to the inlet surface or outlet surface, and a second wing extending orthogonally to the inlet surface or outlet surface, the inlet filter and/or the outlet filter being attached to the first wing and the second wing being attached to the exchange body.

The heat exchanger is of the brazed plate type, said exchange body comprising several plates arranged parallel to one another and to a longitudinal direction, said plates being stacked with spacing so as to define between them the plurality of first passages and the plurality of second passages.

The heat exchanger is an exchanger-reactor configured to implement catalytic reactions between the first fluid and at least one catalyst material, the first passages of the exchange body containing particles of said at least one catalyst material.

The catalyst material comprises particles with an equivalent diameter ranging from a minimum diameter to a maximum diameter, the sheet metallic material being a woven fabric of metallic wires with a mesh opening ranging from 10% to 85% of said minimum diameter of the particles.

The heat exchanger is configured for liquefaction of hydrogen as the first fluid, the catalyst material being configured for conversion of ortho-hydrogen into para-hydrogen, in particular the catalyst material is iron oxide (Fe₂O₃).

According to another aspect, the invention relates to a method for assembling a heat exchanger according to the invention, said method comprising the following steps:
a) attachment, in particular welding, of an outlet filter to the first outlet manifold,
b) positioning of the first outlet manifold below the exchange body in the longitudinal direction, the exchange body being arranged such that the first passages extend parallel to the longitudinal direction which is vertical,
c) attachment, in particular welding, of the first outlet manifold equipped with the outlet filter to the exchange body, said outlet filter being arranged facing the outlet surface of the exchange body,
d) distribution of a catalyst material in the first passages of the exchange body,
e) attachment, in particular welding, of the first inlet manifold to the exchange body, the first inlet manifold being arranged facing the inlet surface of the exchange body.

The invention also concerns a method for liquefaction of a stream of gaseous hydrogen against a stream of refrigerant such as liquid nitrogen, said streams being introduced respectively into the first passages and second passages of a heat exchanger according to the invention.

### BRIEF DESCRIPTION OF THE DRAWINGS

The invention will now be understood better by virtue of the following description, which is given by way of illustrative and non-limiting example and with reference to the appended figures, in which:

FIG. 1 is a three-dimensional view of a heat exchanger according to one embodiment of the invention.

FIG. 2 is a three-dimensional view of a heat exchanger according to another embodiment of the invention.

FIG. 3 shows partial sectional views of passages of an exchange body of a heat exchanger according to one embodiment of the invention.

FIG. 4 shows a filter according to one embodiment of the invention.

FIG. 5 shows a filter according to another embodiment of the invention.

FIG. 6 shows schematically the structure of a filter according to another embodiment of the invention.

FIG. 7 shows a manifold and a filter according to another embodiment of the invention.

FIG. 8 is a partial view of a heat exchanger with a filtration device according to the prior art.

### DETAILED DESCRIPTION OF PREFERRED EMBODIMENTS

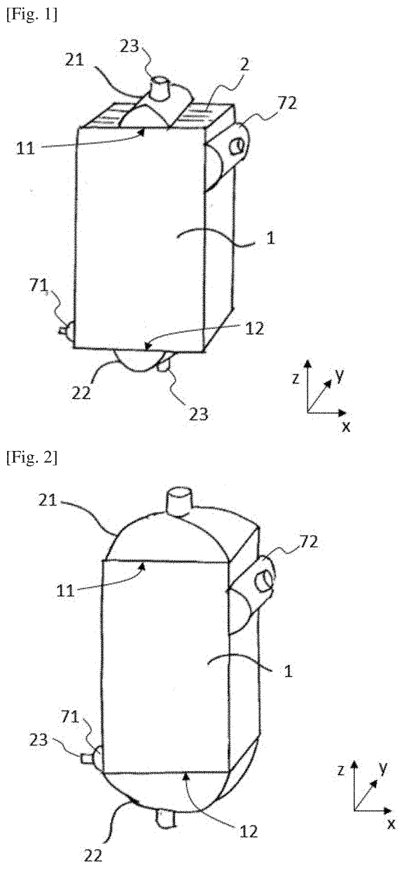

With reference in particular to FIGS. 1, 2 and 3, a heat exchanger according to one embodiment of the invention is of the plate type with brazed fins. The elements constituting the heat exchanger are preferably made from aluminium or aluminium alloy. The heat exchanger comprises an exchange body 1 formed from a stack of plates 2. The plates 2 extend in two dimensions, length and width, in the longitudinal direction z and lateral direction x respectively. The plates 2 are disposed on top of one another, parallel to and spaced apart from one another. They thus form between them a plurality of passages 10, 20, with first passages being provided for the flow of a first fluid F1 and second passages being provided for the flow of at least one second fluid F2 to be brought into an indirect heat-exchange relationship with F1 via the plates 2. The lateral direction x is perpendicular to the longitudinal direction z and parallel to the plates 2. The fluids flow preferably along the length of the exchanger and generally parallel to the longitudinal direction z, the length being great in comparison with the width of the exchanger. The spacing between two successive plates 2, corresponding to the height of a passage and measured in the stacking direction y of the plates 2, is small compared with the length and the width of each successive plate. The stacking direction y is orthogonal to the plates. The first passages 10 may be arranged, wholly or partially, alternating with or adjacent to all or some of the passages 20 of the second series. Preferably, at least some of the passages 10, 20 comprise finned thermal exchange elements, for example corrugated structures, which extend across the width and along the length of the passages of the heat exchanger, parallel to the plates 2.

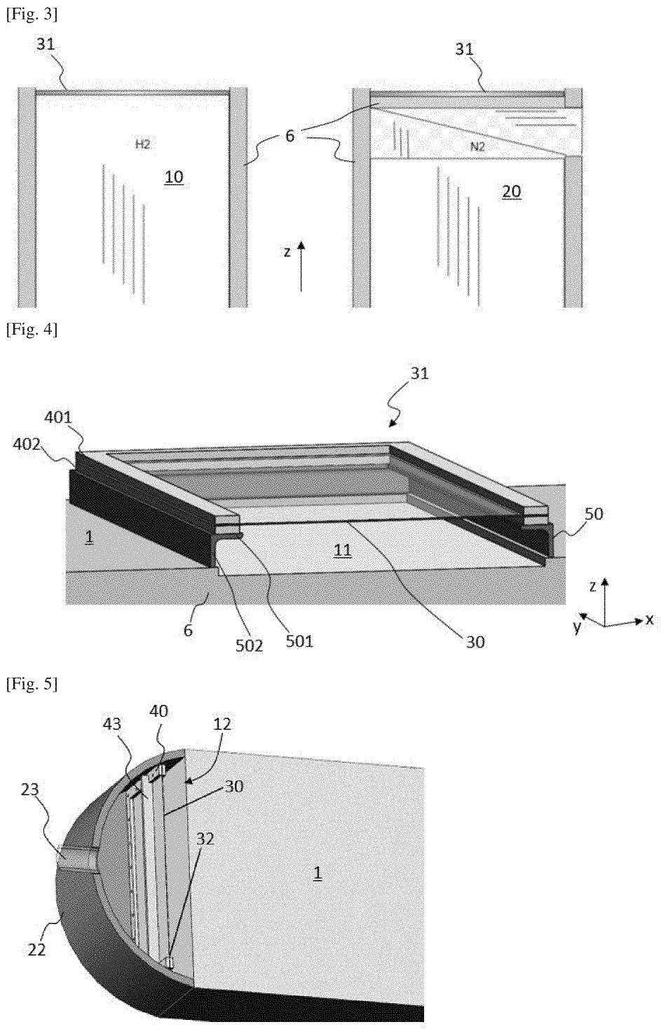

FIG. 3 illustrates the passages of the exchange body and a particular embodiment in which the first passages 10 and second passages 20 are provided respectively for the flow of hydrogen (H₂) as the first fluid and nitrogen (N₂) as the second fluid. When the heat exchanger is used for liquefaction of hydrogen, the hydrogen as the first fluid F1 is the calorigenic fluid and the nitrogen as the second fluid F2 is the refrigerant fluid. It is noted that other fluid compositions may be used for the refrigerant fluid.

Preferably, each passage 10, 20 has a flat and parallelepipedic shape. The body 1 comprises closure bars 6 placed between the plates 2 at the periphery of the passages 10, 20. These bars 6 ensure the spacing between the plates 2 and seal the passages.

In a way known per se, the exchanger comprises distribution and discharge means 21, 22, 71, 72, known as manifolds or collector boxes, attached to the sides of the exchange body 1 and configured to distribute the fluids selectively into the passages 10, 20 and to discharge said fluids from said passages 10, 20. Each manifold has peripheral walls delimiting an internal volume, an open end situated on the side of the exchange body, and a pipe 23 designed for supply or discharge of the fluid into or from the internal volume.

The closure bars 6 do not fully seal the passages but leave openings free on the sides of the body 1 for inlet or outlet of the corresponding fluids. The openings for inlet of each fluid F1 or F2 are arranged congruently one above the other. The openings for outlet of each fluid F1 or F2 are arranged congruently one above the other. The inlet openings 21 of the first passages 10 are fluidically combined in a first inlet manifold 21. The outlet openings of the first passages 10 are fluidically combined in a first outlet manifold 22. The inlet openings of the second passages 20 are fluidically combined in a second inlet manifold 71. The outlet openings of the second passages 20 situated one above the other are fluidically combined in a second outlet manifold 72.

As can be seen on FIG. 1 or FIG. 2, the exchange body 1 has an inlet surface 11 at which the first passages 10 are fluidically connected to the first inlet manifold 21, i.e. the inlet openings of the passages 10 open in said inlet surface. Similarly, the exchange body 1 has an outlet surface 12 at which the first passages 10 are fluidically connected to the first outlet manifold 22.

It is specified that the characteristics of the invention described in the present description in connection with the first fluid F1, i.e. in particular with respect to the first passages, inlet and outlet surfaces etc., are also applicable in full or in part to the second fluid F2. A filtration solution according to the invention is therefore conceivable for all or some of the fluids circulating in the heat exchanger.

According to a possibility illustrated in FIG. 1, the inlet and outlet manifolds 21, 22, 71, 72 are semi-tubular in shape, i.e. semi-cylindrical, and only partially cover the sides of the body on which they are arranged. Distribution corrugations, in the form of corrugated sheets which extend from the inlet or outlet openings and ensure guidance and uniform distribution of the fluids over the entire width of the passages 10, 20, are arranged between successive plates 2.

According to another possibility illustrated in FIG. 2, the inlet and outlet manifolds 21, 22, 71, 72 are dome-shaped and fully cover the sides of the body on which they are arranged.

In embodiments illustrated, the first inlet manifold 21 for the first fluid and the second outlet manifold 72 are situated at one and the same end of the heat exchanger, the fluids F1, F2 thus flowing in contraflow through the body 1. For preference, the longitudinal axis is vertical when the exchanger 1 is in operation. The first inlet manifold 21 for the first fluid is situated at an upper end of the heat exchanger, and the first outlet manifold 22 for the first fluid is situated at a lower end of the heat exchanger. The first fluid F1 flows generally vertically and in the downward direction. Other flow directions for the fluids F1, F2 are of course conceivable, without departing from the scope of the present invention.

As FIG. 4 and FIG. 5 show, the heat exchanger according to the invention also comprises an inlet filter 31 arranged facing the inlet surface 11 of the exchange body 1, and/or an outlet filter 32 arranged facing the outlet surface 12 of the exchange body 1. In other words, the inlet and outlet filters are arranged so as to face the inlet and outlet surfaces respectively. The inlet filter 31 and/or the outlet filter 32 comprises a sheet metallic material 30 selected from a metallic gauze, a non-woven fabric of metallic fibres, a sintered metallic powder or sintered metallic fibres, a micro-perforated plate.

The term “metallic gauze” means a manufactured product obtained by weaving metallic wires, i.e. interlacing wires so as to obtain a metallic woven fabric, i.e. a metallic fabric. It is noted that the term “metallic gauze” may also cover a manufactured product obtained by welding metallic wires, i.e. a welded fabric formed from wires which cross and are spot-welded at the crossing point.

The term “non-woven fabric” or unwoven fabric means a manufactured product formed from fibres arranged in a sheet and oriented randomly or directionally, and connected together by mechanical, chemical or thermal methods or by a combination of these methods, excluding weaving. In particular, the non-woven fabric may be formed from fibres connected by friction, cohesion or adhesion.

The term “sintered” describes a material obtained by sintering of powder or metallic fibres, i.e. by heating a powder or fibres without bringing them to melting point. Under the effect of the heat, the grains or fibres weld together, resulting in the cohesion of the material.

A micro-perforated plate designates a plate with micro-perforations, i.e. continuous passages of micrometric dimension, i.e. smaller than one millimetre.

It is noted that each of the filters may comprise one or more layers of said sheet metallic material.

The use of a metallic gauze, a non-woven metallic fibre fabric, a sintered metal or a micro-perforated plate leads to a material in which the openings or open pores may be dimensioned so as to allow the flow of fluid while preventing the passage of solid particles which should be retained in the exchange body or which should be prevented from entering said body. These materials offer a good compromise between fluid permeability and filtration efficacy, thanks to the small dimensions of the openings which may be obtained, and rigidity of the filter. Thanks to their sheet structure, the filters may be positioned very close to the passages of the exchange body, which allows a significant reduction in the volume of catalyst used in catalytic heat exchangers since the manifolds need no longer be filled with catalyst. The manufacture and use of these filters are simplified in comparison with those of filtration cartridges of the prior art.

The present invention is particularly advantageous when used in a heat exchanger with plates and brazed fins, because of its ease of implementation and assembly. It should be noted that other types of exchangers may however be used, such as plate exchangers, shell and tube exchangers, or core in kettle assemblies, i.e. plate exchangers or plate and fin exchangers embedded in a shell in which the refrigerant fluid vaporises. In the case where the exchangers are tube exchangers, the first and second passages may be formed by the spaces in, around and between the tubes.

Preferably, when the sheet metallic material is a metallic gauze or a micro-perforated plate, it has an open surface density ranging from 15 to 35%, preferably from 17 to 22%. The open surface density, i.e. the permeability of the gauze or plate, is defined as the ratio of the area of the openings or perforations to the total area of the gauze or micro-perforated plate respectively. These value ranges offer a good compromise between rigidity of the material, which gives it a good mechanical strength, and permeability to fluid in order to minimise the load losses.

In the case of sheet metallic materials other than a metallic gauze or micro-perforated plate, these preferably have a pore volume density, i.e. a porosity, of at least 75%, preferably more than 90%, and advantageously less than or equal to 98%. These value ranges allow retention of fine solid particles while offering good mechanical strength and a moderate load loss for the fluid. It should be noted that the pore volume density is defined as the ratio between the volume of the voids in the material and the total volume of the material. It is noted that voids are open pores, i.e. fluidically communicating with the external environment in which the material is situated.

Preferably, the sheet metallic material 30 is formed fully or partly of steel, in particular stainless steel, nickel or nickel alloy, in particular an Inconel-type alloy comprising between 50% and 75% nickel by weight. These materials offer the advantage of good mechanical strength, good durability, and good resilience to cryogenic temperatures. These properties are valuable in the context of resistance to the dynamic fluid pressure and retention of the catalyst weight, in particular when the filter is situated in the lower part of the heat exchanger.

According to a preferred embodiment of the invention, the sheet metal material 30 is a metallic gauze formed from metallic wires 301, 302. More precisely, the material comprises an interlacing of at least one series of first metallic wires 301 with a series of second metallic wires 302 so as to form open meshes 33. Depending on the pattern of weave of the wires, the meshes may be square, rectangular or triangular. The first metallic wires 301 and second metallic wires 302 may have identical characteristics, i.e. material, diameter etc., but not necessarily.

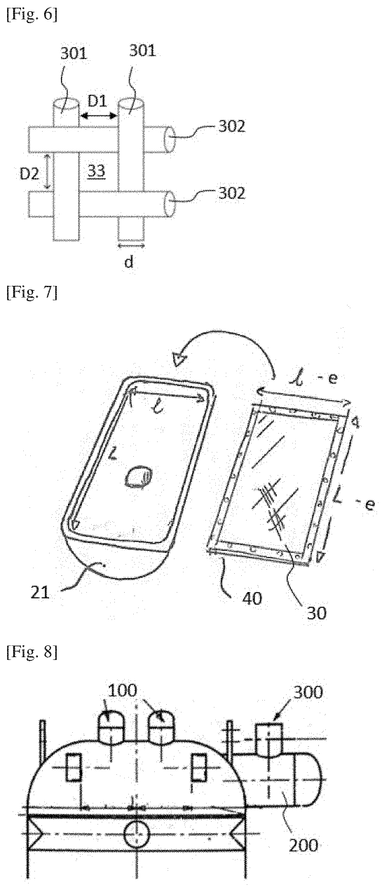

FIG. 6 shows schematically an exemplary weave pattern in which the first wires and second wires cross alternately one below and one above. Other weave patterns are possible, for example wires crossing alternately two below and two above, one below and two above.

It should be recalled that the characteristics listed in the present application for a gauze also apply to the case in which the wires are secured by welding.

Use of a metallic gauze allows precise and reproducible control of the filter characteristics thanks to the geometry of the meshes, which is perfectly controlled during the weaving operation. The regularity of the meshes offers a degree of permeability of the filter which is homogenous over the entire surface; this prevents a reduction in performance of the heat exchanger, thanks to the even distribution of the fluid flow through the filter. In addition, the metallic gauze allows an open surface density, defined by the meshes, for optimal blocking of the target particles and limiting the load losses for the fluid passing through. It also offers good flatness properties, which means that the gauze can be secured without excessive deformation in a frame which can be attached to the body or manifold, in particular a frame which is either brazed to the body of the heat exchanger or welded into the manifold.

Preferably, said wires 301, 302 have a diameter d ranging from 0.10 to 0.30 mm, in particular from 0.10 to 0.25 mm, which gives the gauze a good mechanical strength thanks to the tensile strength of its wires. Further preferably, said wires may have a diameter ranging from 0.12 to 0.18 mm.

Each mesh 33 is delimited between two consecutive first wires 301 and two consecutive second wires 302, wherein the meshes preferably have an opening between 0.07 mm and 0.15 mm. The dimension of the mesh opening is defined so as to retain the solid particles of larger size which should be blocked.

In the case of square or rectangular meshes, as shown on FIG. 6, the mesh opening is defined as the distance D1 between two consecutive first wires 301 and/or the distance D2 between two consecutive second wires 302. In the case of triangular meshes (not shown), the mesh opening is defined as the diameter of the tangent sphere inserted in the mesh.

Preferably, the sheet metallic material 30 has a thickness of 0.2 to 0.75 mm. This thickness gives the material a sufficient mechanical strength. For a metallic gauze, the thickness results from the diameter of the wires and the method of assembly of the formed meshes.

In one possibility, the sheet metallic material is a sintered powder or sintered metallic fibres. In particular, stainless steel or bronze powders may be used, which are bonded by atomic diffusion at a temperature lower than the melting temperature of the material.

According to another possibility, the sheet metallic material is a micro-perforated plate with a plurality of preferably circular orifices, the diameter of which is advantageously between 0.07 mm and 0.15 mm. Preferably, the plate has a thickness between 0.2 mm and 0.5 mm. Preferably, the orifices are uniformly distributed over the micro-perforated plate.

According to an advantageous embodiment shown on FIG. 4 or FIG. 5, the inlet filter 31 and/or the outlet filter 32 comprises a peripheral frame 40 which extends along at least part of the contour of the sheet metallic material 30. In particular, the frame 40 may be formed from an upper part 401 and a lower part 402 superposed on one another, between which the inlet filter 31 or outlet filter 32 is fixed. The peripheral frame 40 stiffens the frame and forms a means for fixing the sheet material 30 to the manifolds and/or exchange body. If the frame is made from two parts, these may be assembled in particular by riveting, welding or screwing. Preferably, the frame 40 is made from aluminium or an aluminium alloy, preferably from the same material as the other elements constituting the heat exchanger and manifolds. Thus the frame may be welded into the manifold and/or onto the body of the exchanger. The frame may be formed from a set of bars, the width of which is between 12 and 25 mm measured parallel to the lateral direction x or the stacking direction y, depending on orientation of the bar concerned, and the height of which is between 3 and 7 mm measured in the longitudinal direction z. These values provide sufficient material for allowing the passage of assembly means such as riveting or bolting means, while not excessively reducing the cross-section of the fluid passage through the filter.

In some cases, the filter 31, 32 may comprise one or more reinforcing bars 43 extending between two opposite edges of the frame 40. This allows stiffening of the filter when the exchange body has larger inlet or outlet surfaces. One example is shown in FIG. 5.

In one possibility, the inlet filter 31 or outlet filter 32 may be attached to the exchange body facing the inlet or outlet surface to be filtered.

It may be attached to the body directly or via an intermediate piece 50, preferably made of aluminium or aluminium alloy of the same type as the body of the exchanger, as shown on FIG. 4. The intermediate piece is preferably fixed to the body by welding. The frame is preferably welded to the intermediate piece. One advantage of using an intermediate piece is the possibility of removing the filter for replacement, for example by separating the frame from the intermediate piece. If no intermediate piece is used, the frame would have to be cut level with the closure bars of the heat exchanger, which risks damaging it.

In applications in which the exchanger must be filled with catalyst, it also allows the positioning of a tray, preferably rectangular in form, intended for filling.

Preferably, the intermediate piece is an angle type piece, i.e. a piece formed from profiles with L-shaped cross section. Preferably, the piece comprises two pairs of opposite sides. FIG. 4 shows an example of an angle piece, with one of the sides not shown in order to reveal the inner part of the device. Preferably, each side of the angle piece comprises a first wing 501 which extends parallel to the filter, and a second wing 502 which extends perpendicularly to the filter. Preferably, the length of the first wing 501 of the piece on which the peripheral frame rests, measured parallel to the lateral direction x or the stacking direction y as applicable, is at least equal to the width of the frame. The second wing 502 of the L is welded to the body of the exchanger 1. By welding the end of the second wing 502 to the angle piece level with the bars forming the opening of the exchanger, as illustrated in FIG. 4, this solution advantageously means there is no need to widen the manifold which will sit on top of the filter, the manifold being welded to the body of the exchanger. If there is no angle-type intermediate piece, the filter would have a larger surface to allow it to rest on the body 1. The manifold would have to be widened accordingly.

The inlet or outlet manifold may be attached to the exchange body 1, to the filter—in particular its peripheral frame—or to each of these elements.

According to a particularly advantageous possibility, the outlet filter 32 is fixed to the outlet manifold 22, and/or the inlet filter 31 is fixed to the first inlet manifold 21. Thus, during production of the heat exchanger, the filter or filters may be attached to the respective manifold before the manifold is attached to the body, which offers the advantage of not having to weld the filter to the body of the exchanger in addition to welding the manifold. Any welding on a brazed body carries a risk of local overheating which may lead to loss of cohesion of the brazed surfaces.

For applications of catalytic exchangers, the combination of two types of assembly may be preferred, namely a filter welded into the outlet manifold, wherein the manifold itself is welded to the lower part of the body of the exchanger, and an inlet filter welded to the body of the exchanger for filling with catalyst.

For exchangers in which the function of the filter is to prevent the entry of particles into the exchanger, the inlet filter may be fixed either in the inlet manifold or on the body of the exchanger.

In the case of an inlet or outlet filter positioned in the manifold, in a section plane parallel to the inlet surface or outlet surface of the exchange body 1, the filter has an outer form which is substantially complementary to the inner form of the first inlet manifold 21 or first outlet manifold 22 in said sectional plane.

Advantageously, the dimensions of the filter are slightly smaller than those of the open end of the manifold, such that the filter is positioned inside the manifold and set back relative to its open end. Preferably, the filter is dimensioned so that it is positioned inside the manifold with a setback of 20 to 25 mm relative to the open end of the manifold. The advantage of a slight setback as indicated is that the volume contained between the body of the exchanger and the filter of the manifold remains limited, which allows limiting of the volume of catalyst used in the case of a catalytic heat exchanger. This setback also offers a good compromise for leaving space for a weld bead produced at the angle between the filter and the wall of the manifold, without impinging on the chamfer conventionally produced at the periphery of the manifold rim. For reasons of feasibility and accessibility, the sealing weld bead is preferably placed on the side of the open section of the manifold.

Advantageously, the inlet and outlet manifold is semi-cylindrical in shape. The filter is held in position thanks to the progressive reduction in the internal dimensions of the manifold. The radius of the inner surface of the manifold allows the filter to be encased therein, which advantageously allows blocking of the filter in preparation for the welding at the periphery of the filter on the inner surface of the manifold.

FIG. 7 illustrates the case in which the manifold has an open end of rectangular inner form, of length L and width I. The filter has a rectangular outer form which is smaller than the dimensions of the open end of the manifold by difference e between 5 and 15 mm.

Depending on the case, the inlet manifold and/or outlet manifold may cover the entirety of the exchange body, or only cover part thereof.

The present invention is particularly advantageous in the case in which the heat exchanger is an exchanger-reactor configured to implement catalytic reactions between the first fluid F1 and at least one catalyst material, the first passages of the exchange body 1 containing said at least one catalyst material in the form of particles. In particular, the heat exchanger is configured for liquefaction of hydrogen as the first fluid F1, the catalyst material being configured for conversion of ortho-hydrogen into para-hydrogen, in particular the catalyst material is iron oxide (Fe₂O₃). In operation, the hydrogen is introduced in the gaseous state through the first inlet manifold 21 and flows into the first passages 10, where it is cooled against a stream of liquid nitrogen flowing in the second passages 20. The hydrogen is discharged in liquid state through the first outlet manifold 22.

Preferably, the catalyst material comprises particles with an equivalent diameter ranging from a minimum particle diameter to a maximum particle diameter. Preferably, the minimum diameter is between 0.2 and 0.4 mm. Preferably, the maximum diameter is between 0.5 and 0.7 mm. Further preferably, the particles of the catalyst material have an equivalent diameter between 0.2 and 0.7 mm.

Preferably, the sheet metallic material 30 is a woven fabric of metallic wires having a mesh opening representing between 30% and 70% of the minimum particle diameter. These ratios are defined so as to block very fine particles or dust resulting from the abrasion of catalyst particles during filling or in operation, while offering a satisfactory compromise with respect to load losses.

The term “equivalent diameter” of a non-spherical particle in the present application means the diameter of the sphere of the same volume as said particle.

The invention also concerns a method of assembling a catalytic heat exchanger, implementation of which is easier and better controlled thanks to the invention. An outlet filter 32 is attached to the first outlet manifold 22. The manifold-outlet filter assembly is then attached to the exchange body 1. The exchange body 1 is positioned vertically and the outlet manifold 22 is attached below the exchange body 1 in the vertical upward direction z. The first passages 10 are then filled with catalyst. The outlet filter 32, positioned in the lower part of the body, retains the catalyst in the passages. Filling may be carried out by means of a tray, which may be rectangular in form, positioned over the exchange body 1 so as to face the openings of the passages to be filled. The tray is removed once filling is completed. The first inlet manifold 21 is attached to the exchange body 1.

Also, the heat exchanger may advantageously comprise an inlet filter 31. The inlet filter 31 is attached to the exchange body 1 facing the inlet surface 11, where applicable with the intermediate piece 50 arranged between the filter 31 and the body 1. Then the first inlet manifold 21 is attached to the exchange body 1 above the inlet filter 31.

For an exchanger in which it is desirable to prevent the intrusion of dust coming from the upstream fluid circuit, it is possible to place the inlet filter 31 in the first inlet manifold 21, and then attach the manifold-inlet filter assembly to the exchange body 1.

It is noted that in the context of the invention, the inlet and/or outlet filters are preferably attached to the previously brazed exchange body 1. Preferably, the filters are attached to the body or manifolds by welding.

This method of attachment is particularly suitable for heat exchangers in which the passages are to be filled with catalyst particles. The passages are filled with the catalyst particles after the exchange body, together with the outlet manifold, has been positioned vertically, which allows gravity filling with the catalyst and better control of the distribution of the catalyst between the different passages.

It is noted that if it is necessary to block the introduction of any particles into the passages of the heat exchanger, the arrangement of an outlet filter on the side of the outlet surface of the body of the exchanger is optional. It is also noted that another inlet filter and/or another outlet filter according to the invention may also be arranged so as to provide one or more functions described in the present application for the second passages 20.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A heat exchanger comprising:
an exchange body having a plurality of first passages for the flow of a first fluid and a plurality of second passages for the flow of a second fluid to be brought into a heat exchange relationship with the first fluid,
a first inlet manifold for introducing the first fluid into the first passages,
a first outlet manifold for discharging the first fluid from the first passages,
the exchange body having an inlet surface at which the first passages are fluidically connected to the first inlet manifold, and an outlet surface at which the first passages are fluidically connected to the first outlet manifold,
an inlet filter arranged facing the inlet surface of the exchange body, and/or an outlet filter arranged facing the outlet surface of the exchange body, the inlet filter and/or the outlet filter comprising a sheet metallic material selected from a metallic gauze, a non-woven fabric of metallic fibres, a sintered metallic powder or sintered metallic fibres.

2. The heat exchanger according to claim 1, wherein the sheet metallic material has an open surface density ranging from 15 to 35% or a pore volume density ranging from 75 to 98%.

3. The heat exchanger according to claim 1, wherein the sheet metallic material is formed fully or partly of steel, in particular stainless steel, of nickel or nickel alloy.

4. The heat exchanger according to claim 1, wherein the sheet metallic material has a thickness of 0.20 to 0.75 mm.

5. The heat exchanger according to claim 1, wherein the sheet metallic material is a woven fabric of metallic wires, said wires having a diameter of 0.10 to 0.30 mm.

6. The heat exchanger according to claim 5, wherein the sheet metallic material comprises at least one series of first metallic wires interlaced with a second series of metallic wires so as to form meshes, each mesh being delimited between two consecutive first wires and two consecutive second wires, the meshes having an opening of 0.07 mm to 0.15 mm.

7. The heat exchanger according to claim 1, wherein the inlet filter and/or the outlet filter comprises a peripheral frame which extends along at least part of the contour of the sheet metallic material and/or the outlet filter is attached between an upper part and a lower part of said peripheral frame.

8. The heat exchanger according to claim 1, further comprising an inlet filter attached to said first inlet manifold, and/or an outlet filter attached to said first outlet manifold, wherein in a section plane parallel to the inlet surface or outlet surface of the exchange body, the inlet filter and/or outlet filter has an outer form which is substantially complementary to the inner form of the first inlet manifold or first outlet manifold in said sectional plane.

9. The heat exchanger according to claim 1, further comprising an inlet filter attached to the exchange body at the inlet surface, and/or an outlet filter attached to the exchange body at the outlet surface.

10. The heat exchanger according to claim 9, wherein the intermediate piece is an angle piece with sides with L-shaped cross-section, each side comprising a first wing extending parallel to the inlet surface or outlet surface, and a second wing extending orthogonally to the inlet surface or outlet surface, the inlet filter and/or the outlet filter being attached to the first wing and the second wing being attached to the exchange body.

11. The heat exchanger according to claim 1, wherein said heat exchanger is of the brazed plate type, said exchange body comprising several plates arranged parallel to one another and to a longitudinal direction, said plates being stacked with spacing so as to define between them the plurality of first passages and the plurality of second passages.

12. The heat exchanger according to claim 1, wherein the exchanger is an exchanger-reactor configured to implement catalytic reactions between the first fluid and at least one catalyst material, the first passages of the exchange body containing particles of said at least one catalyst material.

13. The heat exchanger according to claim 12, wherein the catalyst material comprises particles with an equivalent diameter ranging from a minimum diameter to a maximum diameter, the sheet metallic material being a woven fabric of metallic wires with a mesh opening ranging from 10% to 85% of said minimum diameter of the particles.

14. The heat exchanger according to claim 12, configured for liquefaction of hydrogen as the first fluid, the catalyst material being configured for conversion of ortho-hydrogen into para-hydrogen.

15. A method for assembling a heat exchanger as defined in claim 1, said process comprising the following steps:
a) welding an outlet filter to the first outlet manifold,
b) positioning the first outlet manifold below the exchange body in the longitudinal direction, the exchange body being arranged such that the first passages extend parallel to the longitudinal direction which is vertical,
c) welding the first outlet manifold equipped with the outlet filter to the exchange body, said outlet filter being arranged facing the outlet surface of the exchange body,
d) distribution of a catalyst material in the first passages of the exchange body,
e) welding the first inlet manifold to the exchange body, the first inlet manifold being arranged facing the inlet surface of the exchange body.
